(19) United States
(12) Patent Application Publication
(10) Pub. No.: US 2017/0037920 A1
(43) Pub. Date: Feb. 9, 2017

(54) PISTON-CYLINDER DEVICE

(71) Applicant: Showa Corporation, Gyoda City (JP)

(72) Inventors: Kei FURUKAWA, Gyoda City (JP); Gota NAKANO, Gyoda City (JP); Kouichi ITO, Gyoda City (JP)

(73) Assignee: Showa Corporation, Gyoda City (JP)

(21) Appl. No.: 15/302,911

(22) PCT Filed: Sep. 26, 2014
(86) PCT No.: PCT/JP2014/075646

§ 371 Date: Oct. 7, 2016

(30) Foreign Application Priority Data
May 12, 2014 (JP) 2014-099058

(51) Int. Cl. F16F 9/02; F16F 9/32; E05F 1/10

(52) U.S. Cl. CPC F16F 9/0263; E05F 1/1091; F16F 9/3214; B60J 5/10

(57) ABSTRACT

The gas spring includes a cylindrical cylinder body that stores gas, a piston body that partitions the inside of the cylinder body into a rod-side gas chamber and a piston-side gas chamber as having a flow path capable of allowing gas flow between the rod-side gas chamber and the piston-side gas chamber, a rod body that is connected to the piston body as having a hollow portion, a push rod that moves in the axial direction of the rod body with operation of an operator as being inserted to the hollow portion of the rod body, and a valve that the flow path with movement in the axial direction in the piston body as being arranged separately from the push rod and movable with the push rod.

### CROSS-REFERENCE TO RELATED PATENT APPLICATIONS

This application is a U.S. National Phase application under 35 U.S.C. §371 of International Patent Application No. PCT/JP2014/075646, filed Sep. 26, 2014, and claims the benefit of Japanese Patent Applications No. 2014-099058, filed May 12, 2014, all of which are incorporated by reference herein in their entireties. The International application was published in Japanese on Nov. 19, 2015 as International Publication No. WO/2015/173978 under PCT Article 21(2).

### TECHNICAL FIELD

The present invention relates to a piston-cylinder device.

### BACKGROUND ART

There exists a piston-cylinder device that assists operation to reduce force required for the operation when operating a moving member such as a door of a vehicle and a height-adjustable seat. In some piston-cylinder devices, it is possible to stop the moving member at a midpoint between an unmoved state and a fully-moved state of the moving member.

For example, Patent Document 1 discloses a gas spring that becomes into a free state in which length thereof is variable by allowing circulation of operational fluid when a valve is pushed from the outside and becomes into a locked state in which the length is fixed by blocking the circulation of the operational fluid while the valve is protruded when the valve is released. Here, the gas spring includes a lever supporting portion arranged in the vicinity of the valve, an operational lever that is supported by the lever supporting portion as being relatively movable and is capable of performing switching between the free state and the locked state by pushing or releasing the valve with the relative movement, and a fixing unit that fixes the operational lever to maintain the free state with the valve pushed-in by the operational lever.

### CITED DOCUMENT

### Patent Document

Patent Document 1: JP-2010-264298-A

### SUMMARY OF THE INVENTION

According to a conventional piston-cylinder device capable of stopping a moving member at a midpoint, operability thereof has been insufficient such that an operational portion is required to be operated for moving the moving member maintained at the midpoint again.

An object of the present invention is to improve operability of a gas spring device capable of stopping a moving member at a midpoint.

The present invention provides a piston-cylinder device including a cylindrical cylinder that stores fluid, a piston that partitions inside of the cylinder into a first chamber and a second chamber as having a flow path capable of allowing flow of the fluid between the first chamber and the second chamber, a rod that is connected to the piston as having a hollow portion, a push rod that moves in the axial direction of the rod with operation of an operator as being inserted to the hollow portion of the rod, and a valve that allows/blocks flow of the fluid between the first chamber and the second chamber by opening/closing the flow path with movement in the axial direction in the piston as being arranged separately from the push rod and movable with the push rod.

According to the above configuration, it is possible to maintain a state that flow of the fluid between the first chamber and the second chamber is blocked by operating the push rod once. Thus, operability of the gas spring device can be improved.

Further, the present invention provides a piston-cylinder device including a cylindrical cylinder that stores fluid, a piston that partitions inside of the cylinder into a first chamber and a second chamber and is capable of allowing flow of the fluid between the first chamber and the second chamber, a rod that is connected to the piston and relatively moves with respect to the cylinder, and an operational portion that receives operation of an operator to block flow of the fluid between the first chamber and the second chamber of the piston at a midpoint between a most-compressed state and a most-extended state of the cylinder and the rod.

According to the present invention, it is possible to improve operability of a gas spring device capable of stopping a moving member at a midpoint.

### BRIEF DESCRIPTION OF THE DRAWINGS

FIG. 1 is a schematic structural view of a gas spring of a first embodiment.

FIGS. 2A to 2C are views illustrating a state that the gas spring of the first embodiment is mounted on a vehicle.

FIG. 3 is a view illustrating a piston portion of the first embodiment in detail.

FIGS. 4A and 4B are views illustrating operation of the gas spring of the first embodiment.

FIG. 5 is a view illustrating a piston portion of a modified example of the first embodiment.

FIG. 6 is a view illustrating a piston portion of a second embodiment.

FIGS. 7A and 7B are views illustrating a piston portion of a third embodiment.

FIGS. 8A and 8B are views illustrating a piston portion of a fourth embodiment.

FIGS. 9A and 9B are views illustrating a gas spring of the fifth embodiment.

FIG. 10 is a view illustrating a piston portion of a sixth embodiment.

FIGS. 11A to 11C are views illustrating operation of the gas spring of the sixth embodiment.

FIG. 12 is a view illustrating a piston portion of a seventh embodiment.

FIGS. 13A and 13B are views illustrating a piston portion of an eighth embodiment.

FIG. 14 is a view illustrating an operational handle of a ninth embodiment.

### DETAILED DESCRIPTION OF THE INVENTION

In the following, embodiments of the present invention will be described with reference to the attached drawings.

### First Embodiment

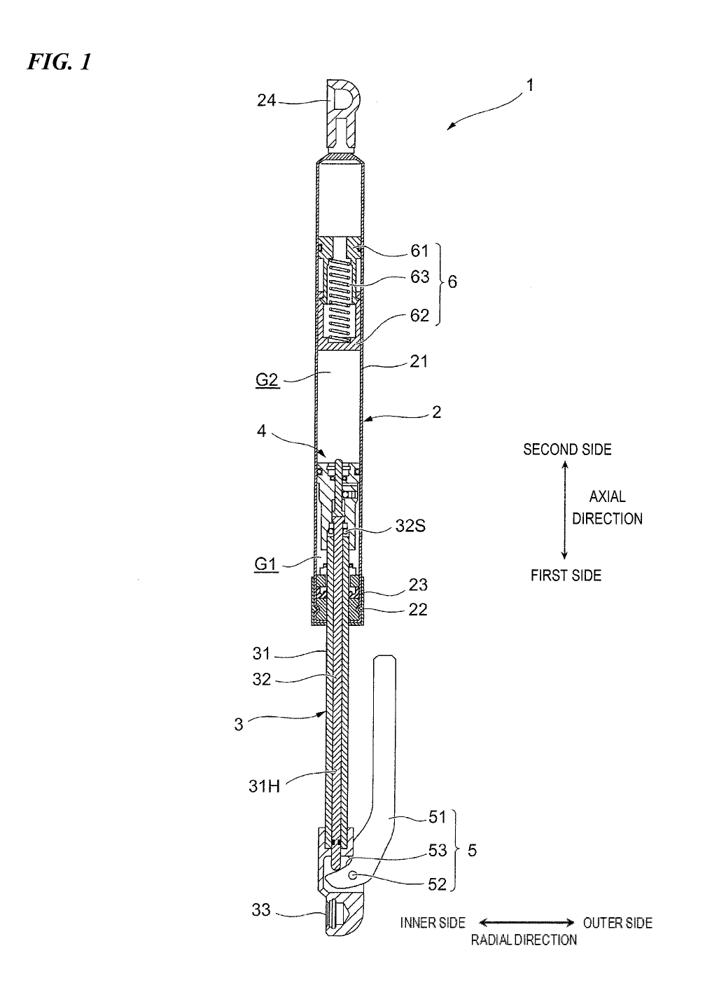

FIG. 1 is a schematic structural view of a gas spring 1 of a first embodiment.

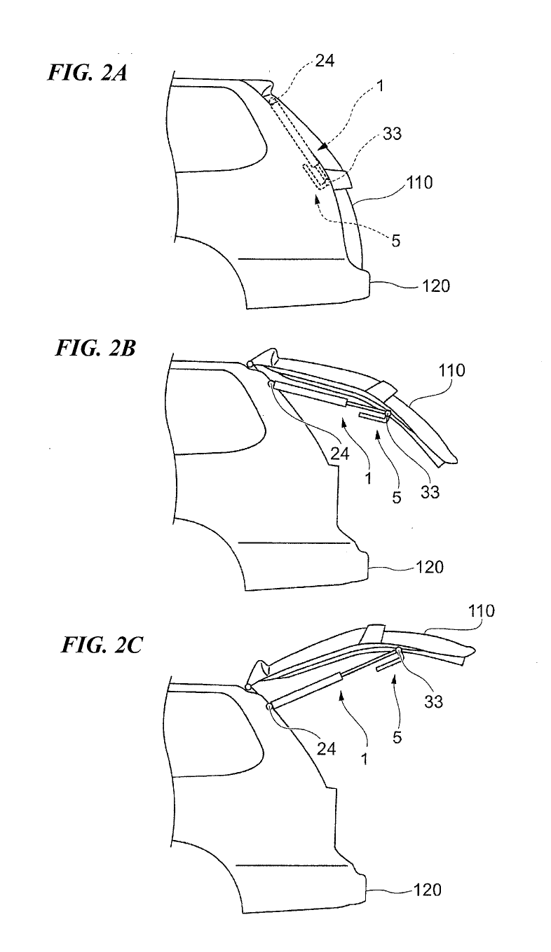

FIGS. 2A to 2C are views illustrating a state that the gas spring 1 of the first embodiment is applied to a vehicle.

### [Structure of Gas Spring 1]

A gas spring 1 illustrated in FIG. 1 is a device to assist opening operation of an operator to lessen necessary force for opening a back door or the like of a vehicle, for example, as being attached between a door 110 and a vehicle body 120 as illustrated in FIGS. 2A to 2C. In the following embodiments, the longitudinal direction of the gas spring 1 illustrated in FIG. 1 is referred to simply as “an axial direction”. The lower side and the upper side in FIG. 1 are referred to as “a first side” and “a second side”, respectively. The lateral direction thereof is referred to as “a radial direction”, while a side toward the center axis and a side apart from the center axis are referred to as “an inner side” and “an outer side”, respectively.

According to the gas spring 1 of the present embodiment, in an example of a vehicle illustrated in FIGS. 2A to 2C, the door can be maintained in a closed state as illustrated in FIG. 2A, a fully-opened state as illustrated in FIG. 2C, or a midpoint state between the closed state and the fully-opened state as illustrated in FIG. 2B.

As illustrated in FIG. 1, the gas spring 1 includes a cylinder portion 2 that stores gas, a rod portion 3 with an end part thereof on a first side protruded from an end part of the cylinder portion 2 and an end part thereof on a second side stored in the cylinder portion 2, a piston portion 4 arranged at the end part on the second side of the rod portion 3, an operational handle 5 arranged on the first side of the rod portion 3, and a releasing portion 6 arranged at the second side of the cylinder portion 2.

Here, a general structure of the gas spring 1 of the present embodiment will be described.

The gas spring 1 (piston-cylinder device) includes a cylindrical cylinder body 21 (cylinder) that stores gas (fluid), a piston body 41 (piston) that partitions the inside of the cylinder body 21 into a rod-side gas chamber G1 (first chamber) and a piston-side gas chamber G2 (second chamber) as having a flow path capable of allowing gas to flow between the rod-side gas chamber G1 and the piston-side gas chamber G2, a rod body 31 (rod) that is connected to the piston body 41 as having a hollow portion, a push rod 32 (push rod) that moves in the axial direction of the rod body 31 with operation of an operator as being inserted to the hollow portion of the rod body 31, and a valve 42 (valve) that allows/blocks gas flow between the rod-side gas chamber G1 and the piston-side gas chamber G2 by opening/closing the flow path with movement in the axial direction in the piston body 41 as being arranged separately from the push rod 32 and movable with the push rod 32.

In the following, each structural component will be described in detail.

### [Function and Structure of Cylinder Portion 2]

The cylinder portion 2 includes the cylindrical cylinder body 21, a rod guide 22 arranged at the end part on the first side of the cylinder body 21, a gas seal 23 arranged at the end part on the first side of the cylinder body 21, and a body-side connecting portion 24 arranged at the end part on the second side of the cylinder body 21.

The cylinder body 21 is formed substantially into a cylinder shape and is made, for example, of metal. Regarding the cylinder body 21, the end thereof in the axial direction on the second side is closed and the end thereof on the first side is opened. The end of the cylinder body 21 on the first side is closed by the gas seal 23. The cylinder body 21 stores fluid such as compressed gas.

Oil is provided into the cylinder portion 2 by the amount of being necessary and sufficient for improving lubricity between the rod portion 3 and the rod guide 22 and maintaining excellent sealing between the rod portion 3 and the gas seal 23.

The rod guide 22 holds the rod portion 3 in a movable manner and guides movement of the rod portion 3 in the axial direction.

The gas seal 23 is arranged on the second side of the rod guide 22 at the end of the cylinder portion 2 on the first side. The gas seal 23 seals the cylinder portion 2 by providing sealing between an outer circumference of the rod portion 3 and an inner circumference of the cylinder body 21.

The body-side connecting portion 24 is fixed to the end of the cylinder portion 2 on the second side and has a substantially circular hole. The gas spring 1 is attached to the vehicle body 120 (see FIGS. 2A to 2C) with the body-side connecting portion 24.

### [Function and Structure of Rod Portion 3]

As illustrated in FIG. 1, the rod portion 3 includes the rod body 31, the push rod 32 arranged at the inner side of the rod body 31, a rod seal member 32S arranged at the end of the push rod 32 on the second side, and a door-side connecting portion 33 arranged at the end of the rod body 31 on the first side.

The rod body 31 being a member elongated in the axial direction includes a hollow portion 31H formed in the axial direction. The push rod 32 is inserted to the hollow portion 31H.

The push rod 32 is arranged at the inner side of the rod body 31 as being movable in the axial direction with respect to the rod body 31. The push rod 32 on the first side is protruded from the end of the rod body 31 on the first side and contacts to a cam portion 53 of the operational handle 5. The push rod 32 on the second side is arranged at the inner side of the piston portion 4 as being capable of contacting to the valve 42 of the piston portion 4.

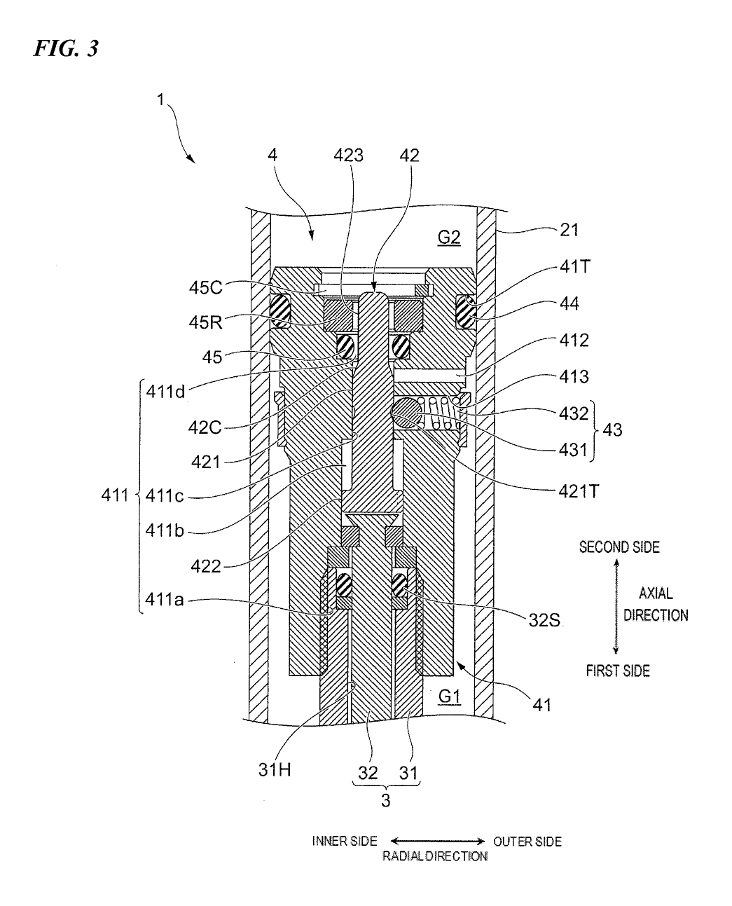

The rod seal member 32S is arranged between the outer circumference of the push rod 32 and the inner circumference of the rod body 31 (see FIG. 3) and provides sealing between the push rod 32 and the rod body 31.

The door-side connecting portion 33 is fixed to the end on the first side and has a circular hole. The gas spring 1 is attached to the door 110 (see FIGS. 2A to 2C) with the door-side connecting portion 33.

### [Function and Structure of Piston Portion 4]

FIG. 3 is a view illustrating the piston portion 4 of the present embodiment in detail.

As illustrated in FIG. 3, the piston portion 4 includes the piston body 41, the valve 42 arranged at the inner side of the piston body 41, a pressing portion 43 arranged at the outer side in the radial direction of the valve 42, a first seal member 44 arranged at the outer circumference of the piston body 41, and a second seal member 45 arranged at the inner circumference of the piston body 41. The piston portion 4 partitions a space in the cylinder portion 2 into the piston-side gas chamber G2 on the second side and the rod-side gas chamber G1 on the first side for storing gas.

### (Piston Body 41)

As illustrated in FIG. 3, the piston body 41 includes a hollow portion 411 extending in the axial direction, a channel 412 extending in the radial direction, and an accommodating portion 413 that accommodates the pressing portion 43 as extending in the radial direction.

The hollow portion 411 includes a first hollow portion 411a formed on the first side, a second hollow portion 411b formed on the second side of the first hollow portion 411a, a third hollow portion 411c formed on the second side of the second hollow portion 411b, and the fourth hollow portion 411d formed on the second side of the third hollow portion 411c.

The rod portion 3 is inserted to the first hollow portion 411a. The end of the rod body 31 on the second side is fixed to the first hollow portion 411a.

The end of the push rod 32 on the second side is inserted to the second hollow portion 411b in a movable manner. A second outer-diameter portion 422 arranged at the end of the valve 42 on the first side is stored at the second hollow portion 411b as well in a movable manner.

The third hollow portion 411c supports a first outer-diameter portion 421 of the valve 42 movably in the axial direction.

The fourth hollow portion 411d faces the piston-side gas chamber G2 on the second side. The second seal member 45 is arranged at the inner side of the fourth hollow portion 411d.

### (Valve 42)

The valve 42 includes the first outer-diameter portion 421 located at the center in the axial direction, the second outer-diameter portion 422 formed on the first side of the first outer-diameter portion 421, a third outer-diameter portion 423 formed on the second side of the first outer-diameter portion 421, and a taper portion 42C formed between the first outer-diameter portion 421 and the third outer-diameter portion 423.

The first outer-diameter portion 421 is formed to have an outer diameter being substantially the same as the inner diameter of the third hollow portion 411c of the piston body 41. The valve 42 is arranged at the piston body 41 as being movable in the axial direction while the first outer-diameter portion 421 is supported by the third hollow portion 411c. The first outer-diameter portion 421 is formed to have the outer diameter being larger than the inner diameter of the second seal member 45.

The first outer-diameter portion 421 includes a ring-shaped groove 421T formed in the circumferential direction. The ring-shaped groove 421T is formed to catch a ball 431 of the pressing portion 43. The location of the ring-shaped groove 421T in the axial direction is arranged to face the ball 431 in a state that the valve 42 allows gas flow between the rod-side gas chamber G1 and the piston-side gas chamber G2.

In the following description, a state in which the valve 42 blocks gas flow between the rod-side gas chamber G1 and the piston-side gas chamber G2 and extension and compression of the gas spring 1 are stopped is called a locked state of the gas spring 1 with the valve 42. In contrast, a state in which the valve 42 allows gas flow between the rod-side gas chamber G1 and the piston-side gas chamber G2 and extension and compression of the gas spring 1 are allowed is called a free state of the gas spring 1 with the valve 42.

The second outer-diameter portion 422 is formed to have an outer diameter being larger than that of the first outer-diameter portion 421. The push rod 32 contacts to the end of the second outer-diameter portion 422 of the valve 42 on the first side. When the valve 42 moves toward the second side in the axial direction, the second outer-diameter portion 422 determines the location of the valve 42 with respect to the piston body 41. According to the second outer-diameter portion 422, the first outer-diameter portion 421 faces the second seal member 45 and the channel 412 in a state that the valve 42 is pushed furthest toward the second side.

The third outer-diameter portion 423 is formed to have an outer diameter being smaller than that of the first outer-diameter portion 421. Here, the outer diameter of the third outer-diameter portion 423 is smaller than the inner diameter of the third hollow portion 411c of the piston body 41 and the inner diameter of the second seal member 45. The third outer-diameter portion 423 faces the piston-side gas chamber G2 at the second side so that the end thereof on the second side receives gas pressure.

The taper portion 42C is arranged so that the first outer-diameter portion 421 and the third outer-diameter portion 423 having different outer diameters are formed continuously in the axial direction. Specifically, the outer diameter on the second side of the taper portion 42C is the same as that of the third outer-diameter portion 423 and the outer diameter on the first side of the taper portion 42C is the same as that of the first outer-diameter portion 421. The taper portion 42C is formed into a tapered shape, so that the outer diameter thereof is gradually enlarged from the second side toward the first side.

Next, description will be provided on relation between the valve 42 and the push rod 32.

As illustrated in FIG. 3, the valve 42 is disconnected from the push rod 32 and formed as a separate body from the push rod 32. The first side of the valve 42 and the second side of the push rod 32 are accommodated in the second hollow portion 411b of the piston body 41. The valve 42 contacts to the push rod 32 in the second hollow portion 411b.

The rod seal member 32S is arranged on the first side in the axial direction further from the second hollow portion 411b. Accordingly, pressure at the second side from the position where the rod seal member 32S is arranged to the push rod 32 is the same as the pressure in the second hollow portion 411b. Here, any seal member is not arranged between the third hollow portion 411c and the first outer-diameter portion 421 of the valve 42. Therefore, in the free state, since gas can flow between the piston-side gas chamber G2 and the second hollow portion 411b through the third hollow portion 411c, the gas pressure in the second hollow portion 411b is the same as that in the piston-side gas chamber G2.

That is, the valve 42 is configured to contact, in the second hollow portion 411b (same-pressure space) where the valve 42 is arranged, to the push rod 32 that is separately formed from the valve 42.

### (Pressing Portion 43)

The pressing portion 43 includes the ball 431 and a spring 432 that is arranged at the outer side in the radial direction of the ball 431.

The ball 431 is formed smaller than the inner diameter of the accommodating portion 413 of the piston body 41. The ball 431 is arranged to be movable in the accommodating portion 413 in the radial direction. The ball 431 is arranged to face the first outer-diameter portion 421 of the valve 42. The ball 431 is configured to be caught by the ring-shaped groove 421T when being faced to the ring-shaped groove 421T.

The spring 432 presses the ball 431 to the valve 42 in the radial direction being the direction intersecting with the axial direction of the valve 42.

The pressing portion 43 is arranged at the piston body 41 and presses the valve 42 in the direction intersecting with the axial direction of the valve 42, so as to determine the position where the valve 42 allows gas flow between the rod-side gas chamber G1 (first chamber) and the piston-side gas chamber G2 (second chamber) (the position in the free state).

### (First Seal Member 44)

The first seal member 44 is arranged on the second side of the piston body 41. The first seal member 44 is held at a ring-shaped groove 41T formed at the outer circumference of the piston body 41. The first seal member 44 provides sealing between the outer circumference of the piston body 41 and the inner circumference of the cylinder body 21.

### (Second Seal Member 45)

The second seal member 45 is arranged in the fourth hollow portion 411d. The second seal member 45 is fixed to the piston body 41 by a ring member 45R and a circlip 45C that are arranged on the second side of the second seal member 45.

The second seal member 45 provides sealing between the inner side of the piston body 41 and the outer side of the valve 42 in accordance with the position of the valve 42 with respect to the piston body 41. Specifically, when being faced to the first outer-diameter portion 421 of the valve 42, the second seal member 45 blocks gas flow between the piston body 41 and the valve 42 and forms the locked state. In contrast, when being faced to the third outer-diameter portion 423 of the valve 42, the second seal member 45 allows gas flow between the piston body 41 and the valve 42 and forms the free state.

Thus, the second seal member 45 is arranged between the inner circumference of the fourth hollow portion 411d (flow path) of the piston body 41 and the outer circumference of the valve 42 and controls gas flow at the piston body 41 along with the valve 42. As described above, the valve 42 includes the third outer-diameter portion 423 (small-diameter portion) and the first outer-diameter portion 421 (large-diameter portion) that has an outer diameter being larger than the third outer-diameter portion 423. Gas flows in the piston body 41 when the third outer-diameter portion 423 is faced to the second seal member 45, and gas flow is blocked when the first outer-diameter portion 421 is faced to the second seal member 45.

### [Function and Structure of Operational Handle 5]

As illustrated in FIG. 1, the operational handle 5 includes a lever 51, a rotational shaft 52 arranged at an end of the lever 51, and a cam portion 53 arranged on a side opposite to the lever 51 with respect to the rotational shaft 52.

The lever 51 is to be grasped by an operator when the operational handle 5 is operated by the operator. In the operational handle 5, the lever 51 is not configured to lock rotational operation. That is, the lever 51 is configured to be freely movable in a state of not being operated by an operator.

The rotational shaft 52 forms the rotational axis of the lever 51. The rotational shaft 52 is supported by the door-side connecting portion 33.

The cam portion 53 is rotated in accordance with rotational operation of the lever 51. When the lever 51 is rotated in one direction, the cam portion 53 pushes the push rod 32 toward the second side. When the lever 51 is rotated in the other direction, the cam portion 53 retreats from the end of the push rod 32 on the first side.

Pressure inside the cylinder body 21 is applied to the second side of the push rod 32, while pressure outside the cylinder body 21 is applied to the first side of the push rod 32. In a state that operation is not provided from the lever 51 to the push rod 32, the push rod 32 is to move toward the first side being the direction to be apart from the valve 42 owing to the inner pressure of the cylinder body 21 being higher than the outer pressure. Accordingly, in a state of not being operated by an operator, the lever 51 is pushed by the push rod 32 that moves toward the first side to be maintained in the initial state before being operated (see FIG. 1).

### [Function and Structure of Releasing Portion 6]

As illustrated in FIG. 1, the releasing portion 6 includes a fixed portion 61 arranged on the second side, a moving portion 62 arranged on the first side of the fixed portion 61, and a spring 63 arranged between the fixed portion 61 and the moving portion 62. The releasing portion 6 contacts to the piston portion 4 when the piston portion 4 is pushed furthest into the cylinder body 21.

The fixed portion 61 is fixed to the inner circumference of the cylinder body 21. The moving portion 62 is arranged movably in the axial direction with respect to the fixed portion 61 and the cylinder body 21. The moving portion 62 is arranged so as to contact to the end of the piston portion 4 on the second side in the most-compressed state of the gas spring 1. The spring 63 urges the moving portion 62 toward the piston portion 4 on the first side.

The valve 42 of the piston portion 4 contacts to the moving portion 62 when the gas spring 1 is most-compressed. Owing to that the valve 42 is pushed toward the first side by the moving portion 62, the valve 42 becomes into the free state.

Owing to that the moving portion 62 is arranged as being movable in the axial direction with the spring 63, it is possible to tolerate margin of errors even when errors of assembling the gas spring 1 and errors of mounting the gas spring 1 on a vehicle and the like occur.

### [Operation of Gas Spring 1]

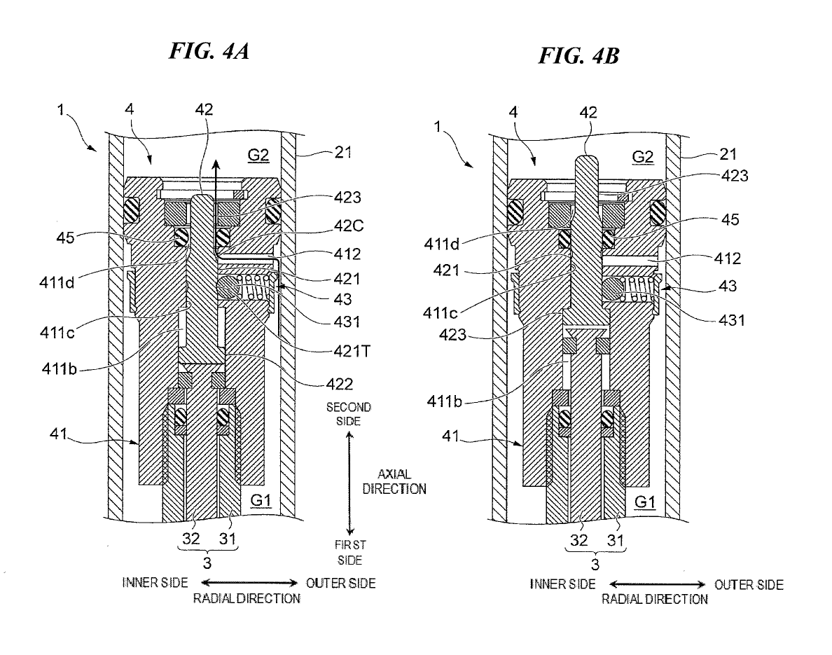

FIGS. 4A and 4B are views illustrating operation of the gas spring 1 of the present embodiment. FIG. 4A illustrates the free state of the gas spring 1 and FIG. 4B illustrates the locked state of the gas spring 1.

As indicated by an arrow in FIG. 4A, for example, when the door 110 is to be opened, the rod portion 3 is moved in a direction of being apart relatively from the cylinder portion 2. That is, the piston portion 4 is to move toward the first side relatively with respect to the cylinder body 21. Owing to the movement of the piston portion 4, gas in the rod-side gas chamber G1 formed on the first side is compressed. The compressed gas flows through the channel 412, the third hollow portion 411c, and a space between the third outer-diameter portion 423 and the second seal member 45 at the fourth hollow portion 411d. Thus, the gas flows into the piston-side gas chamber G2 from the rod-side gas chamber G1.

Since the rod portion 3 is arranged on the first side (rod-side gas chamber G1 side) of the piston portion 4, force oriented toward the second side occurring at the piston portion 4 is represented by the product of gas pressure and pressure-receiving area being the difference between sectional area of the piston portion 4 and sectional area of the rod portion 3. Meanwhile, on the second side of the piston portion 4 (piston-side gas chamber G2 side), force oriented toward the first side occurring at the piston portion 4 is represented by the product of the gas pressure and the sectional area of the piston portion 4. That is, the rod portion 3 receives the force oriented toward the first side corresponding to the product of the gas pressure and the sectional area of the rod portion 3. Here, the operator performs operation of causing the rod portion 3 to move toward the first side being the direction to open the door 110. As described above, the operation to open the door 110 by the operator is assisted by the gas spring 1 owing to that the force occurs to move the rod portion 3 toward the first side.

As illustrated in FIG. 4A, in the free state of the valve 42, the ball 431 of the pressing portion 43 is caught by the ring-shaped groove 421T of the valve 42 and the pressing portion 43 holds the valve 42. Accordingly, movement of the valve 42 in the axial direction is restricted, so that the free state of the valve 42 can be stably maintained.

Here, for example, at a midpoint of that the door 110 is to be opened completely, the lever 51 illustrated in FIG. 1 is rotated. In this case, the push rod 32 is pushed toward the piston portion 4 on the second side.

At that time, as illustrated in FIG. 4B, the valve 42 is moved toward the second side by the push rod 32. Owing to the movement of the valve 42 toward the second side, the first outer-diameter portion 421 of the valve 42 faces the second seal member 45. Accordingly, the valve 42 blocks gas flow between the rod-side gas chamber G1 and the piston-side gas chamber G2 at the piston portion 4. Consequently, the relative movement of the rod portion 3 with respect to the cylinder portion 2 is discontinued and the locked state is obtained. The door 110 to which the gas spring 1 is connected stops at the midpoint being the position when the lever 51 is operated.

The lever 51 is not fixed as acting only with operation of an operator. However, since the valve 42 is maintained in the moved state toward the second side, the door 110 can be stayed at the position without requesting for continuous operation of the lever 51.

Here, since the push rod 32 is moved toward the first side with the inner pressure of the cylinder body 21, the lever 51 can be returned into an initial state before the operation is performed even without operator's operation for returning into the initial state.

Subsequently, for restarting to open the door 110, the operator pushes the door 110 once in the closing direction. Then, gas in the piston-side gas chamber G2 is compressed by the piston portion 4. Owing to the gas pressure in the piston-side gas chamber G2, the valve 42 supported movably with respect to the piston body 41 is moved toward the first side. Accordingly, the gas flow path at the piston body 41 blocked by the valve 42 is to be opened. That is, as illustrated in FIG. 4A, gas can flow in the piston portion 4 through the channel 412, the third hollow portion 411c, and a space between the third outer-diameter portion 423 and the second seal member 45 at the fourth hollow portion 411d. Thus, the free state is obtained. Consequently, the operation of the operator to open the door 110 can be assisted by the gas spring 1.

That is, in the gas spring 1, when the cylinder body 21 and the rod body 31 receives force in a direction to be compressed in a state that gas flow is blocked, the piston portion 4 transfers into a gas flowing state.

Here, for example, in a state that the door 110 is closed, that is, a state that the piston portion 4 is most-pressed in the gas spring 1, the piston portion 4 contacts to the releasing portion 6 as illustrated in FIG. 1. More specifically, the valve 42 of the piston portion 4 contacts to the moving portion 62 of the releasing portion 6. The valve 42 is pushed back toward the first side by the releasing portion 6 as illustrated in FIG. 4A. Accordingly, every time when the door 110 is closed, the free state is provided. Therefore, the gas spring 1 prevents a situation that the door 110 cannot be opened with the locked state maintained in the closed state of the door 110.

As described above, the gas spring 1 (piston-cylinder device) includes the cylindrical cylinder body 21 (cylinder) that stores gas (fluid), the piston body 41 (piston) that partitions the inside of the cylinder body 21 into the rod-side gas chamber G1 (first chamber) and the piston-side gas chamber G2 (second chamber) and allows gas flow between the rod-side gas chamber G1 and the piston-side gas chamber G2, the rod body 31 (rod) that is connected to the piston body 41 and relatively moves with respect to the cylinder body 21, and an operational handle 5 (operational portion) that receives operation of an operator to block gas flow between the rod-side gas chamber G1 and the piston-side gas chamber G2 of the piston body 41 at a midpoint between a most-compressed state and a most-extended state of the cylinder body 21 and the rod body 31.

In the present embodiment, the gas spring 1 transfers into the locked state and the locked state is maintained only by pressing the push rod 32 once as operating the lever 51 without continuing operation of the lever 51 or fixing the lever 51. The door 110 can be stopped at an arbitrary position. Thus, the gas spring 1 of the present embodiment can improve operability.

The gas spring 1 of the present embodiment can improve operability as well in a case of releasing the locked state.

With a related art in which the locked state cannot be released unless the lever 51 is operated, there may be a situation that the lever 51 is extremely difficult to be operated depending on opening space between the door 110 and the vehicle body 120 when the door 110 is stopped (see FIG. 2B.

In contrast, with the gas spring 1 of the present embodiment, the locked state can be released only by directly operating the door 110 without operation of the lever 51. Thus, the gas spring 1 of the present embodiment can improve operability.

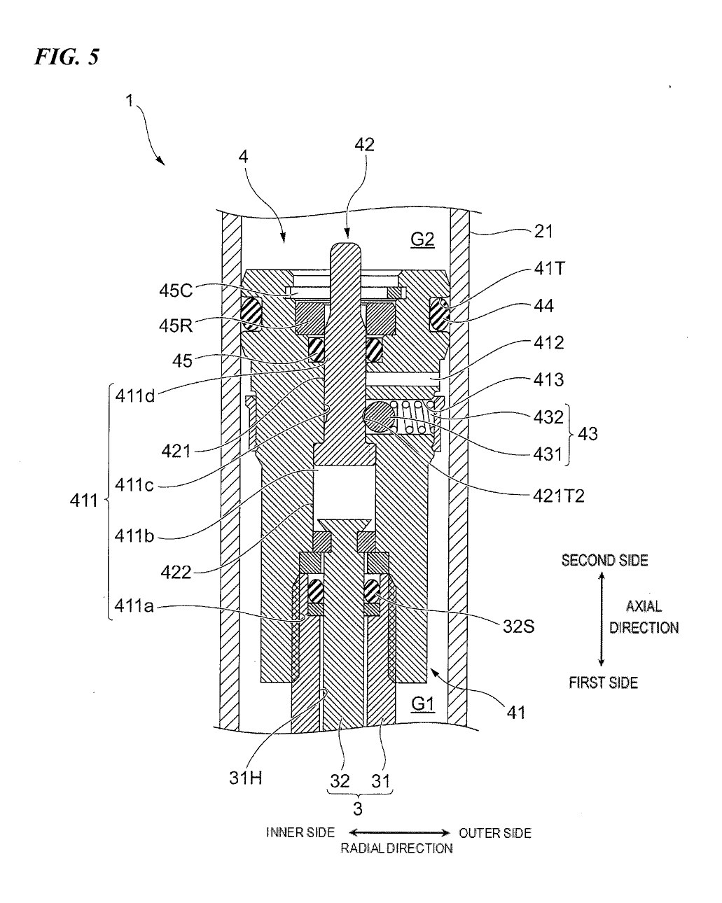

FIG. 5 is a view illustrating the piston portion 4 of a modified example of the first embodiment.

The piston portion 4 of the modified example is different in that the valve 42 includes a second ring-shaped groove 421T2 instead of the ring-shaped groove 421T. In the following, description will be provided on the second ring-shaped groove 421T2 in detail.

The first outer-diameter portion 421 of the valve 42 includes the second ring-shaped groove 421T2 formed in the circumferential direction. The second ring-shaped groove 421T2 is formed to catch the ball 431 of the pressing portion 43. The location of the second ring-shaped groove 421T2 in the axial direction is arranged to face the ball 431 in the locked state that the valve 42 blocks gas flow between the rod-side gas chamber G1 and the piston-side gas chamber G2.

In the piston portion 4 of the modified example structured as described above, the ball 431 of the pressing portion 43 is caught by the second ring-shaped groove 421T2 of the valve 42 in the locked state of the valve 42 and the pressing portion 43 holds the valve 42. Accordingly, movement of the valve 42 in the axial direction is restricted, so that the locked state of the valve 42 can be stably maintained.

### Second Embodiment

Next, description will be provided on the gas spring 1 of a second embodiment.

In the gas spring 1 of the second embodiment, a piston portion 204 is different from the piston portion 4 of the first embodiment. In the following, the piston portion 204 will be described in detail. In the description of the second embodiment, the same reference is given to the similar element of the first embodiment and detailed description thereof will not be repeated.

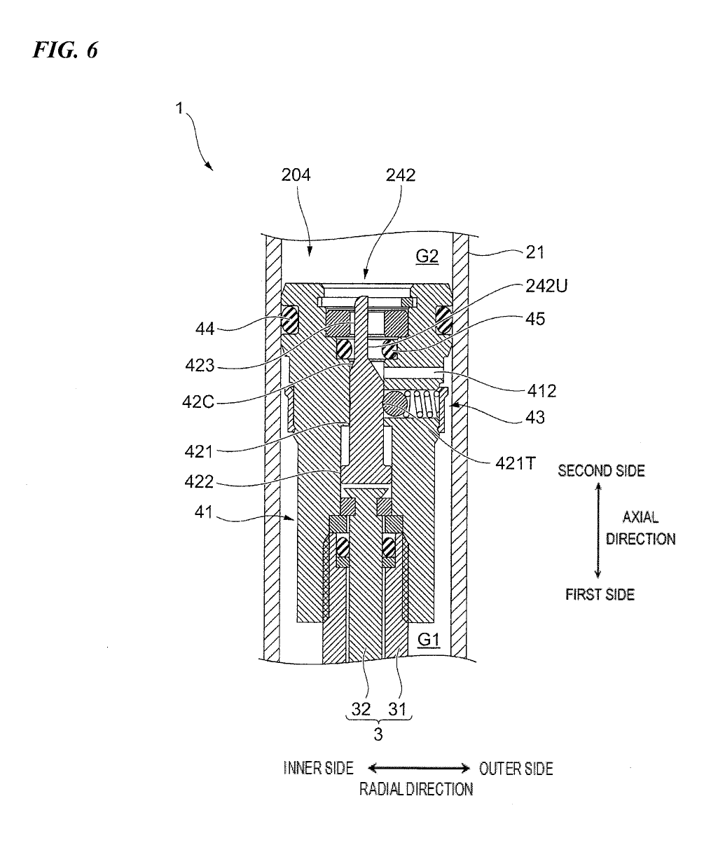

FIG. 6 is a view illustrating the piston portion 204 of the second embodiment.

As illustrated in FIG. 6, the piston portion 204 includes the piston body 41, a valve 242 arranged at the inner side of the piston body 41, the pressing portion 43 arranged at the outer side in the radial direction of the valve 242, the first seal member 44, and the second seal member 45.

The basic structure of the valve 242 is the same as the valve 42 of the first embodiment. The valve 242 includes the taper portion 42C for forming the third outer-diameter portion 423 (small-diameter portion) and the first outer-diameter portion 421 (large-diameter portion) continuously in the axial direction, and a concave portion 242U at the third outer-diameter portion 423 as being largely concaved from the taper portion 42C.

The concave portion 242U is formed on a side facing the channel 412 of the piston body 41. In the free state that the valve 242 is located on the first side, the valve 242 forms a gas flow path between the channel 412 and the second seal member 45. In a state that the taper portion 42C of the valve 242 contacts to the second seal member 45, the concave portion 242U ensures flowing of gas passing through the channel 412 of the piston body 41.

In the piston portion 204 of the second embodiment structured as described above, for example, gas flow from the first side toward the second side being from the rod-side gas chamber G1 toward the piston-side gas chamber G2 in the free state of the valve 242 causes an effect to move the valve 242 toward the second side. Then, the taper portion 42C of the valve 242 contacts to the second seal member 45 and is caught thereby. In this state, the concave portion 242U ensures the gas flow path between the piston body 41 and the valve 242. Thus, in the gas spring 1 of the second embodiment, the free state can be stably maintained.

### Third Embodiment

Next, description will be provided on the gas spring 1 of a third embodiment.

In the gas spring 1 of the third embodiment, a piston portion 304 is different from the piston portion 4 of the first embodiment. In the following, the piston portion 304 will be described in detail. In the description of the third embodiment, the same reference is given to the similar element of the first embodiment and detailed description thereof will not be repeated.

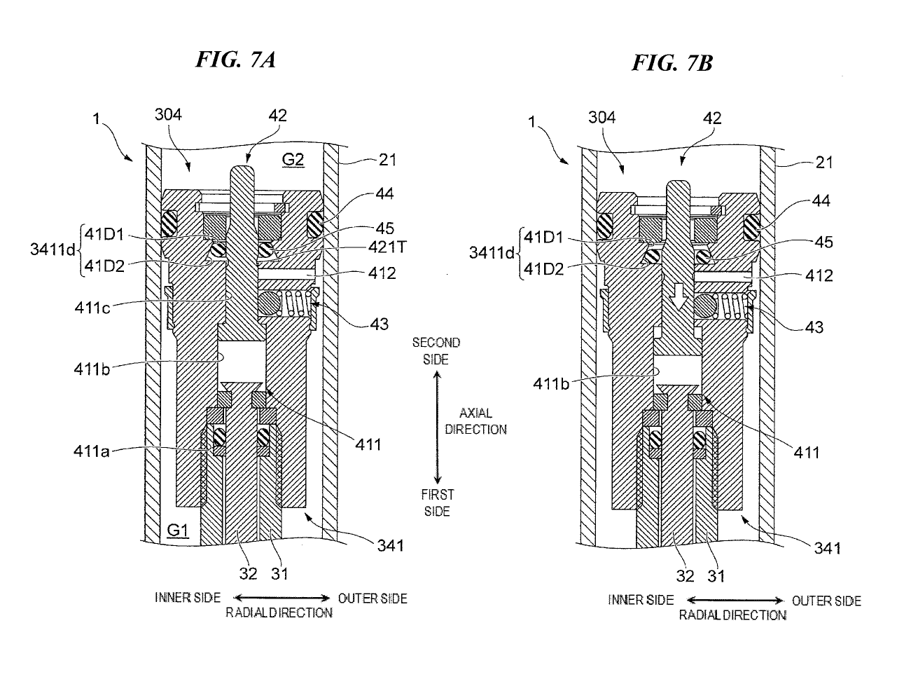

FIGS. 7A and 7B are views illustrating the piston portion 304 of the third embodiment.

As illustrated in FIG. 7A, the piston portion 304 includes a piston body 341, the valve 42 arranged at the inner side of the piston body 341, the pressing portion 43 arranged at the outer side in the radial direction of the valve 42, the first seal member 44, and the second seal member 45.

The basic structure of the piston body 341 is the same as the piston body 41 of the first embodiment. The piston body 341 is different from the first embodiment in the structure of a fourth hollow portion 3411d of the hollow portion 411.

The fourth hollow portion 3411d (holding portion) is formed so that a part for holding the second seal member 45 is shaped to have an inner diameter increasing from the second side toward the rod portion 3. Specifically, the fourth hollow portion 3411d has a first inner-diameter portion 41D1 on the second side and a second inner-diameter portion 41D2 on the first side having an inner diameter being larger than the first inner-diameter portion 41D1.

In the gas spring 1 of the third embodiment structured as described above, the valve 42 moves toward the second side in the locked state of the valve 42 as illustrated in FIG. 7A. At that time, the second seal member 45 is to move toward the second side along with the valve 42. The first inner-diameter portion 41D1 having a smaller inner diameter than the outer diameter of the second seal member 45 is arranged on the second side. Accordingly, the second seal member 45 is compressed and deformed, so that the valve 42 is tightly fastened. Consequently, the second seal member 45 provides reliable sealing between the piston body 341 and the valve 42.

When gas pressure in the piston-side gas chamber G2 is increased by operating the door 110 in the direction of being closed for releasing the locked state provided by the valve 42, the valve 42 moves toward the first side as illustrated in FIG. 7B. At that time, the second seal member 45 is to move toward the first side along with the valve 42. The second inner-diameter portion 41D2 having a larger inner diameter than the outer diameter of the second seal member 45 is arranged on the first side. Accordingly, the fastening to the valve 42 by the second seal member 45 is reduced, so that the valve 42 is easily moved toward the first side. Thus, the valve 42 can be transferred from the locked state to the free state.

### Fourth Embodiment

Next, description will be provided on the gas spring 1 of a fourth embodiment.

In the gas spring 1 of the fourth embodiment, a piston portion 404 is different from the piston portion 4 of the first embodiment. In the following, the piston portion 404 will be described in detail. In the description of the fourth embodiment, the same reference is given to the similar element of the first embodiment and detailed description thereof will not be repeated.

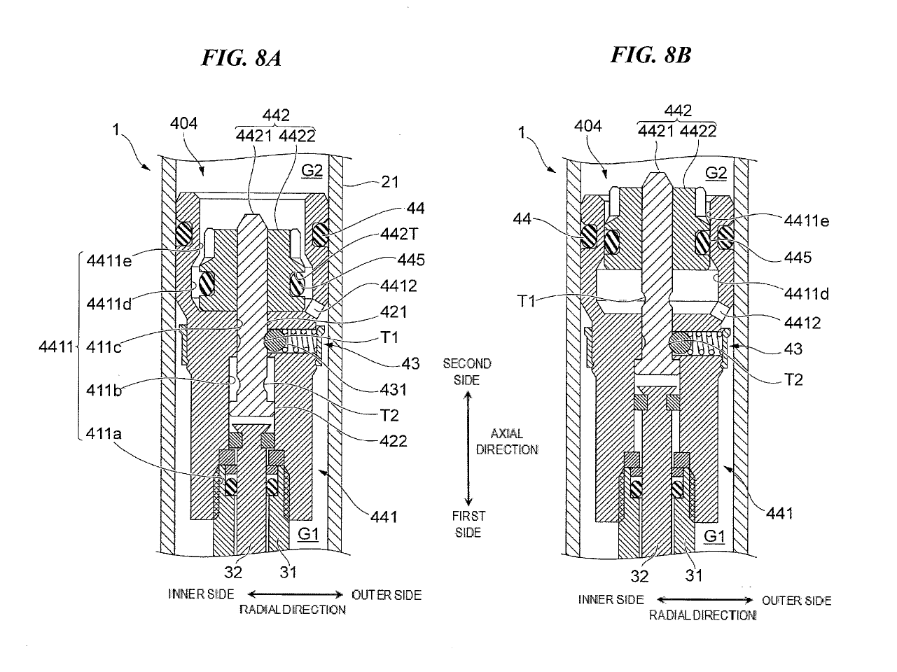

FIGS. 8A and 8B are views illustrating the piston portion 404 of the fourth embodiment. FIG. 8A illustrates the gas spring 1 in the free state and FIG. 8B illustrates the gas spring 1 in the locked state.

As illustrated in FIG. 8A, the piston portion 404 includes a piston body 441, a valve 442 arranged at the inner side of the piston body 441, the pressing portion 43 arranged at the outer side in the radial direction of the valve 442, the first seal member 44, and a third seal member 445.

The piston body 441 is different from the first embodiment in the structure of a hollow portion 4411. Specifically, the hollow portion 4411 includes the first hollow portion 411a, the second hollow portion 411b, the third hollow portion 411c, a fourth hollow portion 4411d formed on the second side of the third hollow portion 411c, and a fifth hollow portion 4411e formed on the second side of the fourth hollow portion 4411d.

The fourth hollow portion 4411d has an inner diameter being smaller than the inner diameter of the third hollow portion 411c. A channel 4412 penetrating in the radial direction is formed at the fourth hollow portion 4411d. The channel 4412 provides communication between the inside of the fourth hollow portion 4411d and the rod-side gas chamber G1.

The fifth hollow portion 4411e has an inner diameter being smaller than the inner diameter of the fourth hollow portion 4411d. The fifth hollow portion 4411e is opened toward the piston-side gas chamber G2.

The valve 442 includes a first valve body 4421 and a second valve body 4422 arranged on the second side of the first valve body 4421.

The first valve body 4421 includes the first outer-diameter portion 421 and the second outer-diameter portion 422 arranged on the first side of the first outer-diameter portion 421.

The first outer-diameter portion 421 has an outer diameter being equal to the inner diameter of the third hollow portion 411c of the piston body 441. The first outer-diameter portion 421 includes a first ring-shaped groove T1 formed in the circumferential direction and a second ring-shaped groove T2 formed in the circumferential direction on the first side further from the first ring-shaped groove T1.

The first ring-shaped groove T1 is formed to catch the ball 431 of the pressing portion 43. The location of the first ring-shaped groove T1 in the axial direction is arranged to face the ball 431 in a state that the valve 442 is at the free state. The second ring-shaped groove T2 is formed to catch the ball 431 of the pressing portion 43. The location of the second ring-shaped groove T2 in the axial direction is arranged to face the ball 431 in the state that the valve 442 is at the locked state.

The pressing portion 43 is arranged at the piston body 441 and presses the first valve body 4421 in the direction intersecting with the axial direction of the first valve body 4421, so as to determine the position where the first valve body 4421 allows gas flow between the rod-side gas chamber G1 (first chamber) and the piston-side gas chamber G2 (second chamber) (the position in the free state and the position in the locked state).

The second valve body 4422 has an outer diameter being equal to the inner diameter of the fifth hollow portion 4411e of the piston body 441. The outer diameter of the second valve body 4422 is smaller than the inner diameter of the fourth hollow portion 4411d.

The outer diameter of the end of the second valve body 4422 on the second side is larger than the outer diameter on the first side of the first valve body 4421. Area of the end (second face) of the valve 442 on the second side (piston side) is larger than area of the end (first face) of the valve 442 on the first side (rod side).

The third seal member 445 is held at the ring-shaped groove 442T formed at the outer circumference of the second valve body 4422. The third seal member 445 provides sealing between the second valve body 4422 and the piston body 441 in accordance with the position of the second valve body 4422 with respect to the piston body 441. Specifically, in a state of facing the fourth hollow portion 4411d of the piston body 441 as illustrated in FIG. 8A, the third seal member 445 allows gas flow between the piston body 441 and the second valve body 4422 to provide the free state. In contrast, in a state of facing the fifth hollow portion 4411e of the piston body 441 as illustrated in FIG. 8B, the third seal member 445 blocks gas flow between the piston body 441 and the second valve body 4422 to provide the locked state.

In the fourth embodiment as well, the gas spring 1 structured as described above can transfer into the locked state only by operating the lever 51 once to move the valve 442 toward the second side. Consequently, the door 110 can be stopped at an arbitrary position while the operation of the gas spring 1 is discontinued.

In the locked state, the ball 431 of the pressing portion 43 is caught by the second ring-shaped groove T2 of the valve 442 and movement of the valve 442 in the axial direction is restricted. Accordingly, the gas spring 1 of the fourth embodiment stably maintains the locked state.

For releasing the locked state, the valve 442 moves toward the first side and transferring into the free state can be performed by operating the door 110 in the closing direction. At that time, in the fourth embodiment, since pressure-receiving area on the second side of the valve 442 is larger than pressure-receiving area on the first side of the valve 442, the valve 442 can be moved reliably toward the first side.

### Fifth Embodiment

Next, description will be provided on the gas spring 1 of a fifth embodiment.

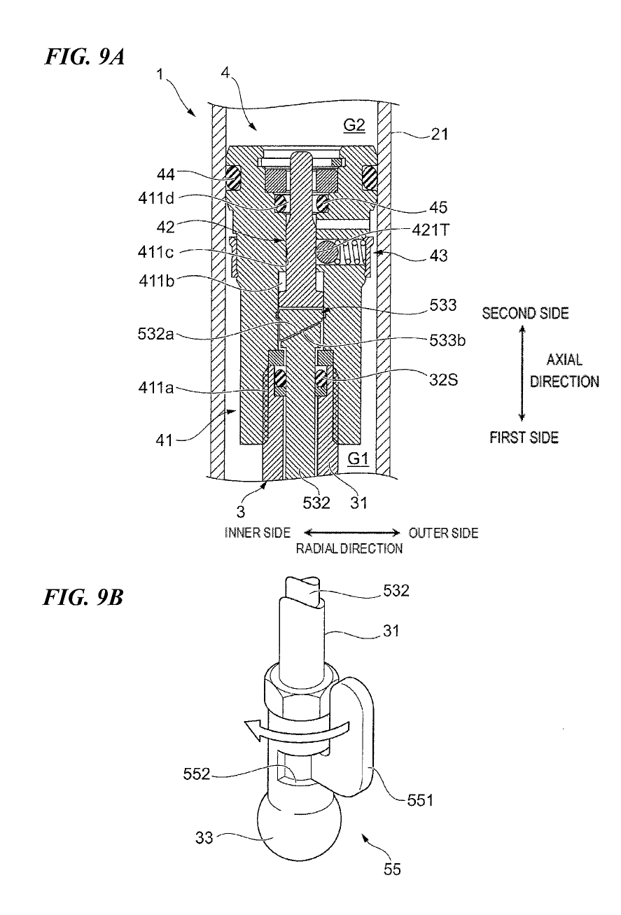

FIGS. 9A and 9B are views illustrating the gas spring 1 of the fifth embodiment.

The basic structure of the gas spring 1 of the fifth embodiment is the same as the first embodiment. Here, the gas spring 1 of the fifth embodiment is different from the other embodiments in that a push rod 532 and a rotary operational handle 55 are provided. In the description of the fifth embodiment, the same reference is given to the similar element of the other embodiments and detailed description thereof will not be repeated.

As illustrated in FIG. 9A, the push rod 532 includes a slant face portion 532a at the end on the second side. A direction converting member 533 is arranged on the second side of the push rod 532 and on the first side of the valve 42.

The slant face portion 532a is formed as being inclined to the axial direction. Since the push rod 532 is formed into a column shape, the end face of the slant face portion 532a is formed into an elliptic shape.

The direction converting member 533 is formed roughly into a column shape and includes a slant face portion 533b on the first side. Since the direction converting member 533 is formed into a column shape, the end face of the slant face portion 533b is formed into an elliptic shape. The slant face portion 533b of the direction converting member 533 faces the slant face portion 532a of the push rod 532. The direction converting member 533 is arranged so as not to be rotated in the circumferential direction while being movable in the axial direction in the second hollow portion 411b of the piston body 41.

That is, the slant face portion 532a of the push rod 532 and the slant face portion 533b of the direction converting member 533 (converting mechanism) is provided to move the valve 42 in the axial direction by converting rotational operation of the push rod 532 performed by an operator into movement in the axial direction of the push rod 532.

As illustrated in FIG. 9B, the rotary operational handle 55 includes a lever 551 and a circumferential guide 552.

The lever 551 is to be grasped by an operator when the rotary operational handle 55 is rotated by the operator. In the rotary operational handle 55, the lever 551 is not configured to lock rotational operation. That is, the lever 551 is configured to be rotatable in accordance with movement of the valve 42 in the axial direction via the direction converting member 533 and the push rod 532 in a state without being operated by an operator.

The circumferential guide 552 is an opening formed in the circumferential direction. The circumferential guide 552 guides the lever 551 to be rotatable in the circumferential direction.

In the gas spring 1 of the fifth embodiment structured as described above, the push rod 532 is rotated when an operator rotates the lever 551. The rotation of the push rod 532 causes the slant face portion 532a of the push rod 532 to rotate. Meanwhile, the slant face portion 533b of the direction converting member 533 does not rotate. Accordingly, owing to that the contact state between the distal end of the slant face portion 532a and the slant face portion 533b is varied, the direction converting member 533 is pushed and displaced in the axial direction. Consequently, the valve 42 is moved by being pushed by the direction converting member 533. The movement of the valve 42 toward the second side provides the locked state.

Since the direction converting member 533 is arranged on the second side further from the rod seal member 32S, the direction converting member 533 is arranged under the same pressure as the gas pressure in the piston-side gas chamber G2 that is applied to the valve 42. Thus, in the gas spring 1 of the fifth embodiment, axial movement of the valve 42 can be actualized with axial movement of the direction converting member 533 that is arranged in the same pressure as for the valve 42. Accordingly, the gas spring 1 of the fifth embodiment can reduce force of an operator necessary for moving the valve 42 to transfer into the locked state.

### Sixth Embodiment

Next, the gas spring 1 of a sixth embodiment will be described.

In the gas spring 1 of the sixth embodiment, a piston portion 604 is different from the piston portion 4 of the first embodiment. In the following, the piston portion 604 will be described in detail. In the description of the sixth embodiment, the same reference is given to the similar element of the first embodiment and detailed description thereof will not be repeated.

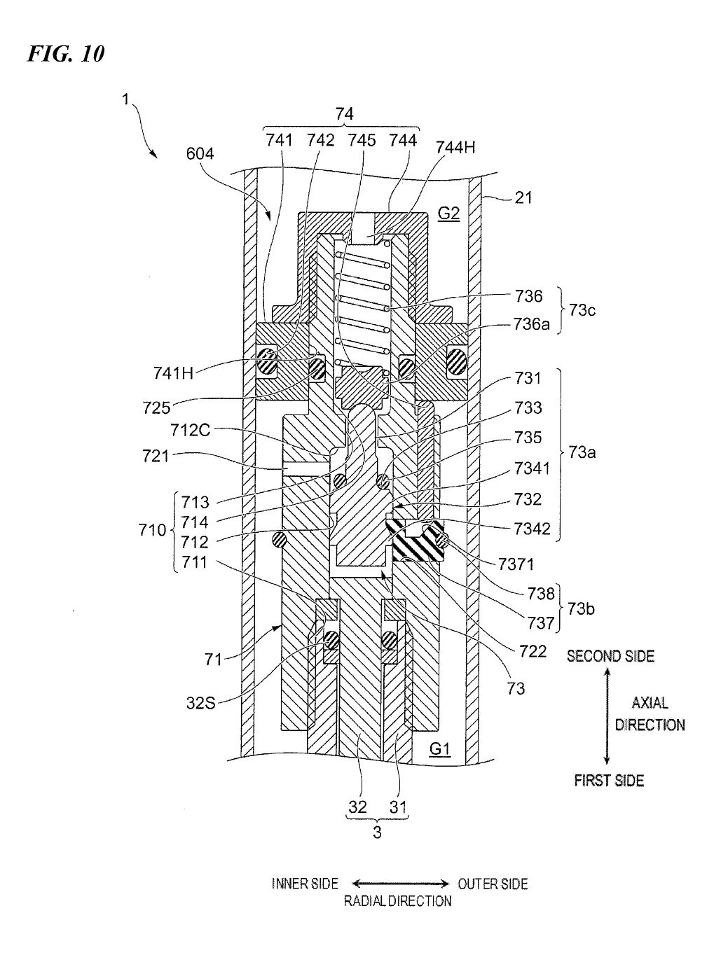

FIG. 10 is a view illustrating the piston portion 604 of the sixth embodiment.

As illustrated in FIG. 10, the piston portion 604 includes a body portion 71 arranged on the first side, a valve 73 arranged at the inner side of the body portion 71, and a releasing portion 74 arranged on the second side. The gas spring 1 of the sixth embodiment includes a ratchet mechanism that holds the valve 73 at a position where the gas flow path is in a closed state (locked state) and a position where the gas flow path is in an opened state (free state).

The body portion 71 includes a hollow portion 710 formed in the axial direction, a radial channel 721 being a gas flow path formed in the radial direction, a ratchet holding portion 722 penetrating in the radial direction, and an outer seal member 725 arranged at the outer side in the radial direction.

The hollow portion 710 includes a first hollow portion 711 formed on the first side, a second hollow portion 712 formed on the second side of the first hollow portion 711, a third hollow portion 713 formed on the second side of the second hollow portion 712, and a fourth hollow portion 714 formed on the second side of the third hollow portion 713.

The end of the rod body 31 on the second side is fixed to the first hollow portion 711.

The end of the push rod 32 on the second side and the end of the valve 73 on the first side are stored at the second hollow portion 712 respectively in a movable manner.

The third hollow portion 713 has an inner diameter being smaller than an inner diameter of the second hollow portion 712. A step portion 712C is formed between the third hollow portion 713 and the second hollow portion 712. The end of the valve 73 on the second side is inserted to the third hollow portion 713 movably in the axial direction.

The fourth hollow portion 714 has an inner diameter being larger than the inner diameter of the third hollow portion 713. A spring 736 and an end member 736a of the valve 73 are stored at the fourth hollow portion 714 in a movable manner.

The radial channel 721 communicates with the rod-side gas chamber G1 at the outer side in the radial direction and with the second hollow portion 712 at the inner side in the radial direction.

The ratchet holding portion 722 holds a ratchet member 737 of the valve 73 in a movable manner.

The outer seal member 725 is arranged between the inner circumference of the releasing portion 74 and the outer circumference of the body portion 71 and provides sealing between the releasing portion 74 and the body portion 71.

The valve 73 includes a tooth portion 73a, a ratchet portion 73b arranged at the outer side in the radial direction of the tooth portion 73a, and a ratchet spring portion 73c arranged on the second side of the tooth portion 73a. The valve 73 includes the ratchet mechanism structured with the tooth portion 73a, the ratchet portion 73b, and the ratchet spring portion 73c. The movement position thereof in the axial direction is maintained by the ratchet mechanism. The valve 73 provides the locked state and the free state in accordance with the relative position with respect to the body portion 71.

The tooth portion 73a includes a first outer-diameter portion 731 formed on the second side, a second outer-diameter portion 732 arranged on the first side of the first outer-diameter portion 731 as having a larger outer diameter than the first outer-diameter portion 731, and a valve step portion 733 that connects the first outer-diameter portion 731 and the second outer-diameter portion 732. Further, the tooth portion 73a includes a first tooth 7341 and a second tooth 7342 formed at the outer circumference, a ratchet seal member 735 arranged on the outer circumference, and a spring 736 arranged on the second side.

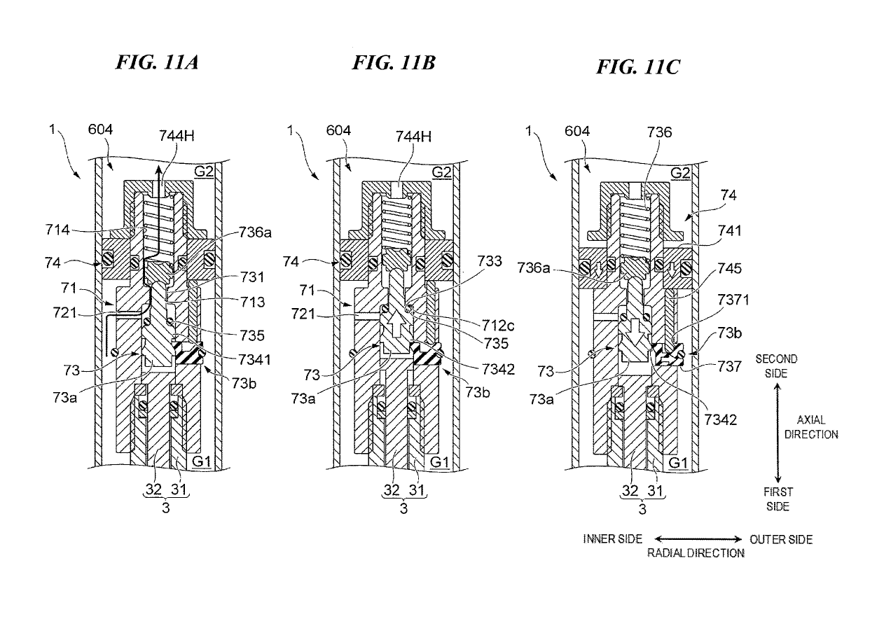

The first tooth 7341 is formed at a position to face the ratchet portion 73b when the valve 73 provides the free state. The second tooth 7342 is formed at a position to face the ratchet portion 73b when the valve 73 provides the locked state (see FIG. 11B).

The ratchet seal member 735 is arranged at the valve step portion 733 and provides sealing between the valve 73 and the hollow portion 710 of the body portion 71.

The ratchet spring portion 73c includes the spring 736, and the end member 736a arranged at the end of the spring 736 on the first side.

The spring 736 exerts spring force to the tooth portion 73a from the second side toward the first side. The end member 736a contacts to the spring 736 on the second side and to the tooth portion 73a on the first side. The end member 736a has an outer diameter being smaller than the inner diameter of the fourth hollow portion 714. Accordingly, gas can flow between the outer circumference of the end member 736a and the inner circumference of the fourth hollow member 714.

The ratchet portion 73b includes the ratchet member 737, and a ratchet ring 738 arranged at the outer side in the radial direction of the ratchet member 737.

The ratchet member 737 is held by the ratchet holding portion 722 of the body portion 71 movably in the radial direction. The ratchet member 737 is formed to be engaged with the first tooth 7341 and the second tooth 7342, respectively. The ratchet member 737 restricts movement of the tooth portion 73a toward the first side in a state of being engaged with the first tooth 7341 or the second tooth 7342. The ratchet member 737 includes a receiving portion 7371 that moves outward in the radial direction when an operational portion 745 of the releasing portion 74 contacts thereto.

The ratchet ring 738 is a ring-shaped member formed of an elastic material such as rubber. The ratchet ring 738 is attached to the outer circumference of the ratchet member 737 and exerts force to the ratchet member 737 inward from the outer side in the radial direction.

The releasing portion 74 includes a releasing body portion 741, a releasing seal member 742 arranged at the outer side of the releasing body portion 741, a stopper 744 arranged on the second side of the releasing body portion 741, and the operational portion 745 arranged on the first side of the releasing body portion 741.

The releasing body portion 741 is a disc-shaped member having an opening 741H at the center thereof. The releasing body portion 741 has an outer diameter being the same as the inner diameter of the cylinder body 21. The releasing body portion 741 has an inner diameter being the same as the outer diameter on the second side of the body portion 71. The releasing body portion 741 is arranged to be movable relatively with respect to the cylinder body 21 and with respect to the body portion 71 as well.

The releasing seal member 742 is arranged between the outer circumference of the releasing body portion 741 and the inner circumference of the cylinder body 21 and provides sealing between the releasing body portion 741 and the cylinder body 21.

The stopper 744 is a bottomed cylinder-shaped member fixed to the body portion 71. The stopper 744 restricts the releasing body portion 741 from being moved toward the second side further from the stopper 744 with respect to the body portion 71. The stopper 744 is arranged at a position to provide a state that the operational portion 745 retreats from the ratchet portion 73b.

The stopper 744 has a through-hole 744H penetrating in the axial direction. The through-hole 744H communicates with the piston-side gas chamber G2 on the second side and the fourth hollow portion 714 of the body portion 71 on the first side.

The second side of the operational portion 745 is fixed to the releasing body portion 741 and the first side thereof faces the ratchet portion 73b. The operational portion 745 advances to and retreats from the receiving portion 7371 of the ratchet member 737 in accordance with movement of the releasing body portion 741.

### [Operation of Gas Spring 1 of Sixth Embodiment]

FIGS. 11A to 11C are views illustrating operation of the gas spring 1 of the sixth embodiment.

Gas in the rod-side gas chamber G1 is compressed in an extension stroke of the gas spring 1. At that time, as illustrated in FIG. 11A, the valve 73 is in a state that the ratchet portion 73b faces the first tooth 7341. That is, the free state is formed in the gas spring 1.

Gas in the rod-side gas chamber G1 flows through the radial channel 721, between the tooth portion 73a and the third hollow portion 713, between the end member 736a and the fourth hollow portion 714, and through the through-hole 744H. Then, the gas flows into the piston-side gas chamber G2. According to the gas flow, force causing the rod portion 3 to extend in the extending direction is generated in the gas spring 1 of the sixth embodiment, so that operation to open the door 110 is assisted.

When the valve 73 is moved toward the second side by operating the push rod 32 as illustrated in FIG. 11B, the valve step portion 733 of the valve 73 and the step portion 712C of the body portion 71 move closer to each other and the ratchet seal member 735 provides sealing between the valve 73 and the body portion 71. Consequently, gas flow at the hollow portion 710 of the body portion 71 is blocked. That is, the locked state is formed in the gas spring 1.

In this state, gas flow between the rod-side gas chamber G1 and the piston-side gas chamber G2 is blocked and extension of the gas spring 1 is discontinued, so that the door 110 is stopped at the position.

Subsequently, when the door 110 is operated into the closing direction, gas pressure in the piston-side gas chamber G2 is increased and the releasing body portion 741 is pushed toward the first side as illustrated in FIG. 11C. Then, owing to that the operational portion 745 pushes the receiving portion 7371 of the ratchet member 737, the ratchet member 737 moves outward in the radial direction. Accordingly, the ratchet portion 73b retreats from the tooth portion 73a. Since the tooth portion 73a is urged toward the first side by the spring 736 through the end member 736a, the tooth portion 73a moves toward the first side.

Consequently, the gas spring 1 transfers into the free state again as illustrated in FIG. 11A.

As described above, in the sixth embodiment as well, the gas spring 1 transfers into the locked state simply by pressing the push rod 32 once. Further, the locked state can be released only by directly operating the door 110 in the closing direction. Thus, in the sixth embodiment, operability of the gas spring 1 can be improved.

### Seventh Embodiment

Next, description will be provided on the gas spring 1 of a seventh embodiment.

In the gas spring 1 of the seventh embodiment, a piston portion 804 is different from the piston portion 4 of the first embodiment. In the following, the piston portion 804 will be described in detail. In the description of the seventh embodiment, the same reference is given to the similar element of the first embodiment and detailed description thereof will not be repeated.

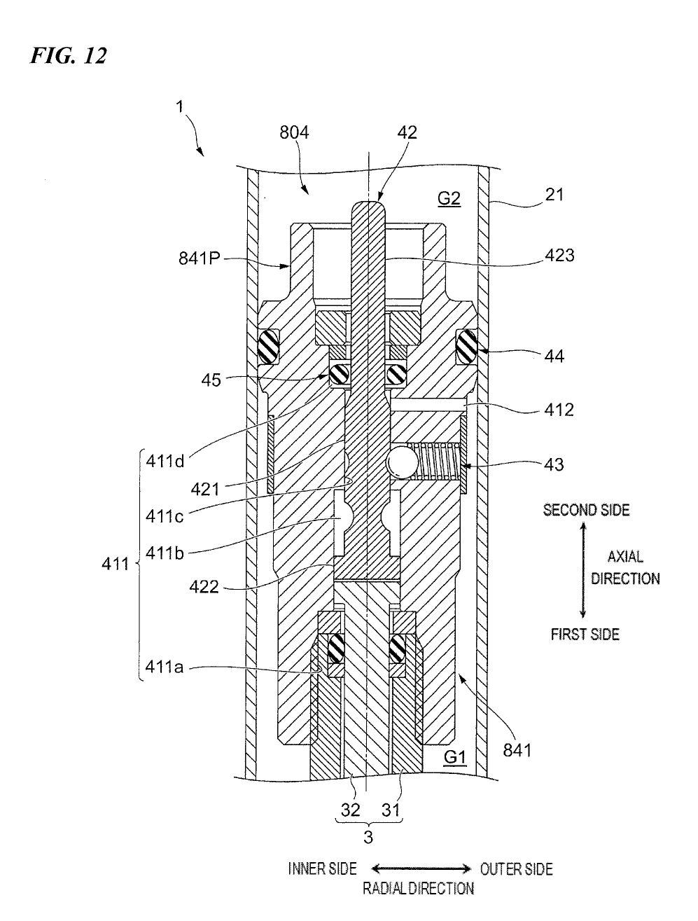

FIG. 12 is a view illustrating the piston portion 804 of the seventh embodiment.

As illustrated in FIG. 12, the piston portion 804 includes a piston body 841, the valve 42, the pressing portion 43, the first seal member 44, and the second seal member 45. That is, in the seventh embodiment, the structure of the piston body 841 is different from that of the piston body 41 of the first embodiment. In the following, description will be provided on the structure of the piston body 841 being different from that of the piston body 41 of the first embodiment.

As illustrated in FIG. 12, the piston body 841 includes a protruding portion 841P. The protruding portion 841P is formed into a cylindrical shape. The gas spring 1 is attached to between the door 110 and the vehicle body 120 with the second side of the piston body 841 oriented upward (e.g., see FIG. 2A). Oil is provided into the cylinder body 21, as described above. According to the piston portion 804, oil is easily collected at the outer side in the radial direction of the protruding portion 841P. Accordingly, oil is easily supplied to the first seal member 44 located at the outer side in the radial direction of the protruding portion 841P. Thus, lubricity between the first seal member 44 and the cylinder body 21 is improved in the gas spring 1 of the seventh embodiment.

### Eighth Embodiment

Next, description will be provided on the gas spring 1 of an eighth embodiment.

In the gas spring 1 of the eighth embodiment, a piston portion 904 is different from the piston portion 4 of the first embodiment. In the following, the piston portion 904 will be described in detail. In the description of the eighth embodiment, the same reference is given to the similar element of the first embodiment and detailed description thereof will not be repeated.

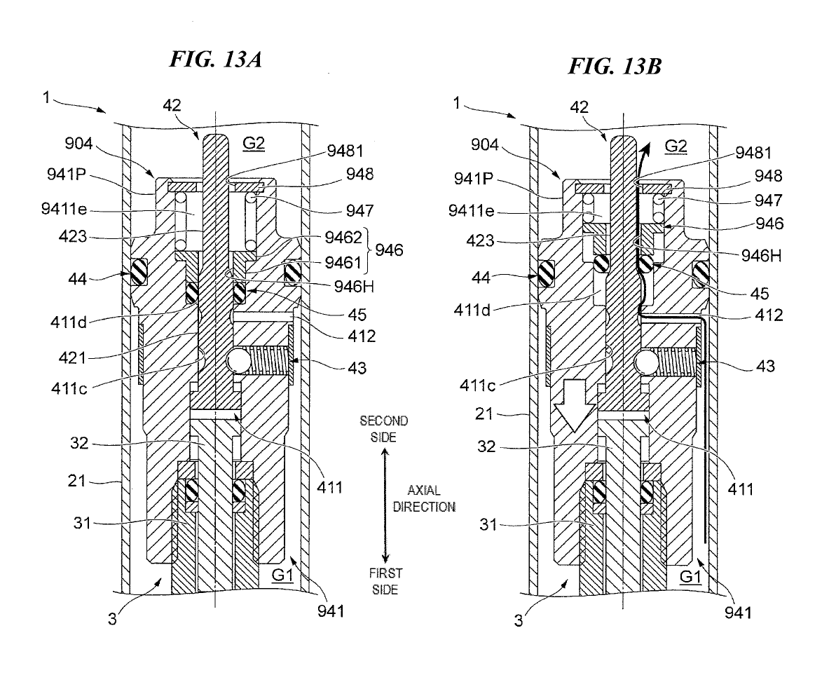

FIGS. 13A and 13B are views illustrating the piston portion 904 of the eighth embodiment.

As illustrated in FIGS. 13A and 13B, the piston portion 904 includes a piston body 941, the valve 42, the pressing portion 43, the first seal member 44, the second seal member 45, a collar 946 arranged on the second side of the second seal member 45, a spring 947 arranged on the second side of the collar 946, and a clip 948 arranged on the second side of the spring 947. That is, the structure of the piston body 941, the collar 946, the spring 947, and the clip 948 of the piston portion 904 of the eighth embodiment is different from the piston portion 4 of the first embodiment. In the following, description will be provided on the structure being different from the first embodiment.

As illustrated in FIGS. 13A and 13B, the piston body 941 includes a protruding portion 941P on the second side. The protruding portion 941P is formed into a cylindrical shape. A fifth hollow portion 9411e continuing to the fourth hollow portion 411d is formed inside the protruding portion 941P.

The collar 946 includes an opening 946H penetrating in the axial direction. The collar 946 includes a cylindrical portion 9461, and a flange portion 9462 arranged on the second side of the cylindrical portion 9461.

The collar 946 is arranged at the fourth hollow portion 411d and the fifth hollow portion 9411e of the piston body 41 movably in the axial direction. The cylindrical portion 9461 contacts to the second seal member 45 and the flange portion 9462 contacts to the spring 947. The inner diameter of the opening 946H is substantially equal to the outer diameter of the first outer-diameter portion 421 and larger than the outer diameter of the third outer-diameter portion 423.

The collar 946 is arranged in a movable manner on the second side of the second seal member 45. Accordingly, the second seal member 45 is movable in the axial direction at the fourth hollow portion 411d.

The spring 947 exerts spring force to the collar 946. The spring 947 exerts the force, to the second seal member 45, causing the second seal member 45 to be pushed toward the first side at the fourth hollow portion 411d via the collar 946. The spring force of the spring 947 is set so that the spring 947 is compressed by gas pressure in the cylinder body 21 generated when an operator performs operation to extend the gas spring 1 in the locked state.

The clip 948 is a ring-shaped member having an opening 9481 at the inside thereof and is fixed to the inner circumference of the fifth hollow portion 9411e of the piston body 41. The clip 948 causes the end of the spring 947 on the second side to be supported by the inner circumference of the fifth hollow portion 9411e of the piston body 41.

In the gas spring 1 of the eighth embodiment structured as described above, when the push rod 32 is pushed toward the second side with operation of the lever 51, the valve 42 is moved toward the second side as illustrated in FIG. 13A. Then, the valve 42 blocks gas flow between the rod-side gas chamber G1 and the piston-side gas chamber G2 with the second seal member 45. Consequently, extension of the gas spring 1 is stopped and the locked state of the gas spring 1 is formed.

Here, it is assumed, for example, that an operator opens the door 110 with the gas spring 1 being in the locked state without performing operation of pushing the door 110 in the closing direction to put the gas spring 1 into the free state. In this case, as illustrated in FIG. 13B, the rod portion 3 is moved toward the first side relatively with respect to the cylinder portion 2. Consequently, gas pressure in the rod-side gas chamber G1 is increased. The increased gas pressure in the rod-side gas chamber G1 is exerted to the second seal member 45 through the channel 412. The second seal member 45 moves toward the second side along with the collar 946 while compressing the spring 947.

Since the operation to put the gas spring 1 into the free state has not been performed, the valve 42 stays as being located at the second side. Accordingly, when the seal member 45 moves toward the second side, the second seal member 45 faces the third outer-diameter portion 423 of the valve 42.

Subsequently, description will be provided on gas flow in the state that the second seal member 45 has moved toward the second side. Gas having pressure increased at the rod-side gas chamber G1 flows into the piston-side gas chamber G2 through the channel 412, the third hollow portion 411c, the fourth hollow portion 411d, the second seal member 45, the collar 946, the fifth hollow portion 9411e, and the clip 948. Subsequently, when pressure difference vanishes between the rod-side gas chamber G1 and the piston-side gas chamber G2, the second seal member 45 is automatically pushed back by the spring force of the spring 947.

Here, description will be provided for comparison on an example without having the structure of the piston portion 904 of the eighth embodiment. In the example for comparison, when an operator performs operation to extend the gas spring 1 in the locked state, force is exerted to the rod portion to move the rod portion toward the first side. Since gas flow is not generated between the rod-side gas chamber G1 and the piston-side gas chamber G2, the piston portion cannot move toward the first side. Accordingly, there is a possibility that load is exerted on a connecting part between the piston portion and the rod portion.

In contrast, in the gas spring 1 of the eighth embodiment, it is possible to reduce the load exerted to the piston portion 904 and the rod portion 3 occurring when an operator performs operation to extend the gas spring 1 in the locked state.

Since the piston portion 904 of the eighth embodiment includes the protruding portion 941P on the second side, oil is easily collected at the outer side in the radial direction of the protruding portion 941P, similarly to the seventh embodiment. Accordingly, lubricity between the first seal member 44 and the cylinder body 21 is improved as well in the gas spring 1 of the eighth embodiment.

### Ninth Embodiment

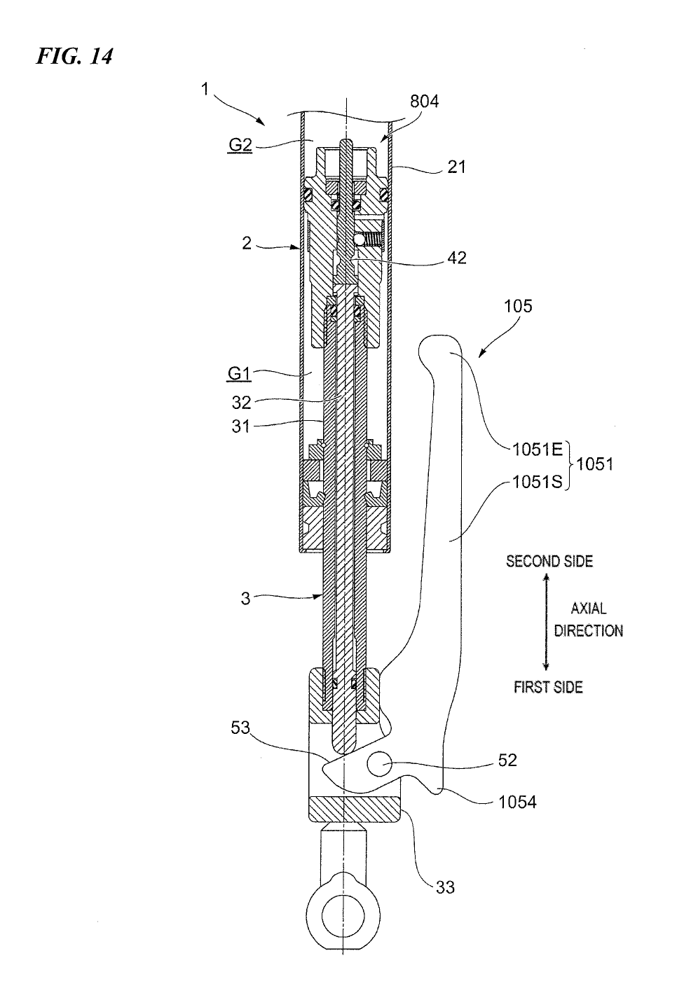

FIG. 14 is a view illustrating an operational handle 105 of a ninth embodiment. The gas spring 1 having the piston portion 804 of the seventh embodiment is illustrated in FIG. 14 as an example. In the following description, the same reference is given to the similar element of the first embodiment and detailed description thereof will not be repeated.

The operational handle 105 includes a lever 1051, the rotational shaft 52, the cam portion 53, and a stopper portion 1054. The operational handle 105 may be made of resin or metal. When the operational handle 105 is made of metal, strength of the operational handle 105 is increased and operation reliability thereof is improved.

The lever 1051 includes a shaft portion 1051S extending in one direction and a lever end 1051E formed on the second side of the shaft portion 1051S. The shaft portion 1051S is formed to be narrowed gradually from the first side toward the second side. The lever end 1051E has width wider than the end of the shaft portion 1051S on the second side. The lever end 1051E is rounded to have a curved shape. Accordingly, the lever 1051 is easy to be grasped by an operator, so that operability thereof is improved.

When the lever 1051 is operated in a direction to push the push rod 32, the stopper portion 1054 contacts to the door-side connecting portion 33. The stopper portion 1054 limits rotation in the pushing direction of the push rod 32 with the lever 1051 to a constant amount. Accordingly, in the gas spring 1 of the ninth embodiment, the push rod 32 is prevented from being pushed beyond necessity.

In the examples of the first to ninth embodiments, the body-side connecting portion 24 of the cylinder portion 2 is attached to the vehicle body 120 and the door-side connecting portion 33 of the rod portion 3 is attached to the door 110. Not limited to the above, it is also possible that the attaching relation between the vehicle body 120 and the door 110 is reversed.

Further, it is also possible that the first ring-shaped groove T1 stably maintaining the free state and the second ring-shaped groove T2 stably maintaining the locked state in the axial direction are arranged, for example, in the valve 42 of the first embodiment or the valve 242 of the second embodiment as in the valve 442 of the fourth embodiment described with reference to FIGS. 8A and 8B.

In the examples of the first to ninth embodiments, the gas spring 1 is arranged between the vehicle body 120 and the door 110. Not limited to the above, the gas spring 1 may be arranged in other aspects as long as being arranged between extending/contracting members or opening/closing members. In such cases, extending/contracting operation or opening/closing operation to be performed by an operator can be assisted.

### DESCRIPTION OF REFERENCES

1 Gas spring
2 Cylinder portion
3 Rod portion
4 Piston portion
5 Operational handle
6 Releasing portion
21 Cylinder body
31 Rod body
32 Push rod
41 Piston body
42 Valve
43 Pressing portion
44 First seal member
45 Second seal member
G1 Rod-side gas chamber
G2 Piston-side gas chamber

1. A piston-cylinder device, comprising:
a cylindrical cylinder that stores fluid;
a piston that partitions inside of the cylinder into a first chamber and a second chamber as having a flow path capable of allowing flow of the fluid between the first chamber and the second chamber;
a rod that is connected to the piston as having a hollow portion;
a push rod that moves in the axial direction of the rod with operation of an operator as being inserted to the hollow portion of the rod;
a valve that allows/blocks flow of the fluid between the first chamber and the second chamber by opening/closing the flow path with movement in the axial direction in the piston as being arranged separately from the push rod and movable with the push rod; and
a seal member that is arranged at an outer side in the radial direction of the push rod and seals flow of the fluid,
wherein the valve contacts to the push rod in same-pressure space where the valve is arranged.

2. (canceled)

3. The piston-cylinder device according to claim 1, further comprising a second seal member that controls, along with the valve, flow of the fluid through the flow path of the piston as being arranged between an inner circumference of the flow path of the piston and an outer circumference of the valve,
wherein the valve includes a small-diameter portion and a large-diameter portion having an outer diameter being larger than the small-diameter portion; and
the valve allows flow of the fluid through the flow path when the small-diameter portion faces the second seal member and blocks flow of the fluid when the large-diameter portion faces the second seal member.

4. The piston cylinder device according to claim 1, further comprising a pressing portion arranged at the piston and presses the valve in a direction intersecting with an axial direction of the valve,
wherein the pressing portion defines a position of the valve for allowing flow of the fluid between the first chamber and the second chamber.

5. The piston-cylinder device according to claim 3,
wherein the valve includes a taper portion for forming the small-diameter portion and the large-diameter portion continuously in the axial direction, and a concave portion at the small-diameter portion as being largely concaved from the taper portion, and
the concave portion maintains flow of the fluid through the flow path in a state that the taper portion is in contact with the second seal member.

6. The piston-cylinder device according to claim 3, further comprising a holding portion that is arranged in the piston to hold the second seal member as having an inner diameter increasing from the piston side toward the rod side.

7. The piston-cylinder device according to claim 1, wherein the valve is arranged so that area of a second face on the piston side is larger than area of a first face of the rod side.

8. The piston cylinder device according to claim 1, further comprising a converting mechanism that moves the valve in the axial direction by converting rotational operation of the push rod by an operator into movement of the push rod in the axial direction.

9. The piston-cylinder device according to claim 1, further comprising a mechanism that allows movement of the valve toward a position where the flow path is in a closed state and restricts movement of the valve toward a position where the flow path is in an opened state.

10. The piston-cylinder device according to claim 1, further comprising an operational portion that receives operation of an operator to move the push rod,
wherein the operational portion is moved in a direction to be apart from the valve owing to that the push rod receives pressure of the fluid in the cylinder.

11. The piston-cylinder device according to claim 1,
wherein the cylinder forms the first chamber on the rod side and the second chamber on the piston side, and
an end of the valve faces the second chamber.

12. The piston-cylinder device according to claim 11, wherein the valve forms the flow path through which the fluid flows from the first chamber to the second chamber.

13. A piston-cylinder device, comprising:
a cylindrical cylinder that stores fluid;
a piston that partitions inside of the cylinder into a first chamber and a second chamber and has a flow path capable of allowing flow of the fluid between the first chamber and the second chamber;
a rod that is connected to the piston and relatively moves with respect to the cylinder;
a valve that allows/blocks flow of the fluid between the first chamber and the second chamber by opening/closing the flow path with movement in the piston; and
an operational portion that is arranged separately from the valve and receives operation of an operator to move the valve,
wherein, when the valve moves with operation of an operator to a flow-blocked position where flow of the fluid is blocked between the first chamber and the second chamber, the valve stays at the flow-blocked portion where flow of the fluid is blocked regardless of operation of the operational portion.

14. The piston-cylinder device according to claim 13, wherein the piston transfers into a state of allowing flow of the fluid when force is exerted in a direction to compress the cylinder and the rod in a state that flow of the fluid is blocked.

15. The piston-cylinder device according to claim 3, wherein the valve is arranged movably on the piston so that it becomes into a state where the small-diameter portion is faced to the second seal member when the cylinder and the rod receive a force in a direction to be compressed in a state where the large-diameter portion is faced to the second seal member

16. The piston-cylinder device according to claim 1, further comprising an operational portion that is movably arranged with no mechanism to fix its position and receives operation of an operator to move the push rod.

17. The piston-cylinder device according to claim 16, wherein the push rod receives an outside pressure of the cylinder at its first side and receives an inside pressure of the cylinder at its second side, so that a force to cause movement toward the operational portion side is exerted by a difference between the outside pressure and the inside pressure of the cylinder.
